(19) United States
(12) Patent Application Publication
(10) Pub. No.: US 2014/0122510 A1
(43) Pub. Date: May 1, 2014

(54) DISTRIBUTED DATABASE MANAGING METHOD AND COMPOSITION NODE THEREOF SUPPORTING DYNAMIC SHARDING BASED ON THE METADATA AND DATA TRANSACTION QUANTITY

(71) Applicant: SAMSUNG SDS CO., LTD., Seoul (KR)

(72) Inventors: Young Hwan NAMKOONG, Seoul (KR); Dong Min SHIN, Seoul (KR); Mi Hyun YOON, Seoul (KR)

(73) Assignee: SAMSUNG SDS CO., LTD., Seoul (KR)

(21) Appl. No.: 14/063,059

(22) Filed: Oct. 25, 2013

(30) Foreign Application Priority Data
Oct. 31, 2012 (KR) 10-2012-0122460

(51) Int. Cl. G06F 17/30

(52) U.S. Cl. CPC G06F 17/30943
USPC 707/755

(57) ABSTRACT

The present invention relates to a method of managing a distributed database and constituent nodes of the database. According to the present invention, it is possible to perform flexible, automatic, and dynamic sharding that can sense whether a specific node needs to be sharded, and can automatically apply an optimal sharding strategy to be applied to database sharding or provide the optimal sharding strategy to at least a manager, by establishing an optimal measure on the basis of the database configuration, the data size, and the transaction quantity for each data.

### CROSS-REFERENCE TO RELATED APPLICATION

This application claims priority from Korean Patent Application No. 10-2012-0122460 filed on Oct. 31, 2012 in the Korean Intellectual Property Office, and all the benefits accruing therefrom under 35 U.S.C. 119, the contents of which in its entirety are herein incorporated by reference.

### TECHNICAL FIELD

The exemplary embodiments relate to a method of managing a distributed database and constituent nodes of the database. More particularly, the present invention relates to a method of managing a distributed database supporting dynamic sharding based on metadata and data transaction quantity, and constituent nodes of the database, in which the method supports distribution management of data flexibly, continuously, and automatically in accordance with accumulation of distributionally stored data and generation of transactions, and nodes constitute a distributed database system operated by the method.

### BACKGROUND

In the field of database, sharding means a method of distributionally storing and reading data in physically different databases in a horizontal partition way and means horizontal partitioning of one database with individual partitions called shards. When sharding is performed, as compared with management of one large database, each shard can be provided with more support of calculation resources, such that the data processing speed increases, and when duplication technology is used, even if there is an error in a shard, the service can be provided from another shard; therefore, there is an effect of improvement of reliability.

There is a MongoDB as a solution that supports sharding. This technology is generally used for non-relational data. Main features relating to data partition are as follows. Data partitioning is based on the storage unit called a chunk and each of data storage nodes dividedly stores a similar number of chunks. The MongoDB uses a data partition method that separates data into two chunks and moves one of them to another node, when a chunk increases to a predetermined size or more. The MongoDB uses the data partition method in a way of keeping the nodes constituting a system, separating a chunk into two parts and uniformly redistributing them to the nodes when a chunk increases to a predetermined size or more. Further, the function of automatically adding a node when a data node needs to be added is not provided.

Other than the MongoDB, there are some solutions that support sharding, such as DBshards and ScaleBase. However, the sharding support solutions described above have the following problems:
Change (e.g. node partition) is very difficult in a data storage/management system constructed on the basis of distributed environment, after data is separated and stored.
Modulus hashing is used as a partitioning strategy in most systems, but the user has to select and apply the partitioning strategy in person for systems providing other references (e.g. date/time range and master lookup).
Due to the reasons described above, the user has to very carefully select an appropriate partitioning strategy before starting and at the time of distributionally storing data in order to improve performance. Accordingly, it takes a great deal of effort to analyze data for distributionally storing the data.
Most systems separate data on the basis of one partitioning strategy, when divisionally storing data. There is a problem in this case in that data may concentrate on specific nodes and unbalanced transaction load may be exerted in the data.

### SUMMARY

An exemplary embodiment provides a method of managing distributed data including: selecting a partition target node on the basis of the data size of a database and in-node transaction quantity, generating a sharding strategy, using meta information and transaction log of the in-node database data, for the selected partition target node, and sharding at least a portion of the database data in the node to a newly generated node in accordance with the sharding strategy.

Another exemplary embodiment provides constituent nodes of a distributed database system which selects a partition target node on the basis of the data size of a database and in-node transaction quantity, generates a sharding strategy, using meta information and transaction log of the in-node database data, for the selected partition target node, and shards at least a portion of the database data in the node to a newly generated node in accordance with the sharding strategy.

Yet another exemplary embodiment provides a method of managing distributed data in which the constituent nodes of a distributed database system each manage a plurality of sharding strategies and determine by the constituent nodes whether to perform sharding and a sharding strategy to use for sharding, in accordance with whether the degree of node concentration according to each of the sharding strategies exceeds a partition limit.

Still another exemplary embodiment provides constituent nodes of a distributed database system in which the constituent nodes of a distributed database system each manage a plurality of sharding strategies and determine by the constituent nodes whether to perform sharding and a sharding strategy to use for sharding, in accordance with whether the degree of node concentration according to each of the sharding strategies exceeds a partition limit.

The objects of the exemplary embodiments are not limited to those described above and other objects not stated herein may be clearly understood by those skilled in the art from the following description.

According to the exemplary embodiments, it is possible to perform flexible, automatic, and dynamic sharding that can sense whether a specific node needs to be sharded, and can automatically apply an optimal sharding strategy to be applied to database sharding or provide the optimal sharding strategy to at least a manager, by establishing an optimal measure on the basis of the database configuration, the data size, and the transaction quantity for each data.

Further, it is possible to optimally distribute transactions in accordance with the data accumulation situation by applying various sharding references, if necessary.

In addition, since a new node is automatically introduced to the distributed database system, if necessary, a new node is automatically introduced due to an increase of data and the database is automatically reconstructed by the system.

In the first aspect of the present invention, there is provided A method of managing a distributed database, the method comprising: selecting a database partition target node from constituent nodes of a distributed database system on the basis of at least one of the data size of the database and the transaction quantity generated for the nodes; generating a sharding strategy to be applied to the partition target node by using meta information and the transaction log of the database data included in the partition target node, by means of the partition target node, the sharding strategy including a shard key and a shard function; and sharding at least a portion of database data of the partition target node to one or more new nodes in accordance with the generated sharding strategy, by means of the partition target node.

In the second aspect of the present invention, there is provided A method of managing a distributed database, the method comprising: managing a plurality of sharding strategies including a shard key, a shard function, a node concentration degree function, and a sharding limit, by means of constituent nodes of a distributed database system; monitoring whether a sharding strategy with the value of function of the degree of node concentration over the sharding limit is generated by means of the constituent nodes; designating a node with a performed sharding strategy, which is a sharding strategy exceeding the sharding limit found by the monitoring, in the constituent nodes as a partition target node; and sharding at least a portion of the database data of the partition target node to one or more new nodes in accordance with the performed sharding strategy.

In the third aspect of the present invention, there is provided A constituent node of a distributed database, the constituent node comprising: a processor; and a storage storing database data of the node, meta information of the data, and transaction information of the node, wherein the processor performs a data sharding process including: selecting a database partition target node from constituent nodes of the distributed database system on the basis of at least one of the data size of the database and transaction quantity generated for the nodes; generating a sharding strategy to be applied to the partition target node by using meta information and the transaction log of the database data included in the partition target node, the sharding strategy including a shard key and a shard function; and sharding at least a portion of database data of the partition target node to one or more new nodes in accordance with the generated sharding strategy.

In the forth aspect of the present invention, there is provided A constituent node of a distributed database, the constituent node comprising: a processor; and a storage storing database data of the node, meta information of the data, and transaction information of the node, wherein the processor performs a data sharding process including: managing a plurality of sharding strategies including a shard key, a shard function, a function of the degree of node concentration, and a sharding limit, monitoring whether a sharding strategy with the value of the function of the degree of node concentration over the sharding limit is generated, and sharding at least a portion of the database data to one or more new nodes in accordance with a performed sharding strategy when the performed sharding strategy, which is a sharding strategy, over the sharding limit is found by the monitoring.

### BRIEF DESCRIPTION OF THE DRAWINGS

The above and other features and advantages of the exemplary embodiments will become more apparent by describing in detail embodiments thereof with reference to the attached drawings in which:

FIG. 1 is a conceptual diagram illustrating the concept of database sharding;

FIGS. 2A and 2B are diagrams illustrating configuration topology of a distributed database system constituted according to an exemplary embodiment;

FIG. 3 is a flowchart illustrating a method of managing a distributed database according to an exemplary embodiment;

FIG. 4 is a conceptual diagram illustrating a process of determining a partition target node in accordance with an exemplary embodiment;

FIG. 5 is a conceptual diagram illustrating a process of determining a sharding strategy on the basis of the size of the DB data in a partition target node in accordance with an exemplary embodiment;

FIG. 6 is a conceptual diagram illustrating a process of determining a sharding strategy on the basis of metadata and the in-node transaction quantity, for the DB data in a partition target node in accordance with an exemplary embodiment;

FIG. 7 is a block diagram illustrating the configuration of a constituent node in a distributed database according to an exemplary embodiment;

FIG. 8 is a conceptual diagram illustrating that a constituent node of a distributed database manages a plurality of sharding strategies in accordance with an exemplary embodiment;

FIG. 9 is a flowchart illustrating a method of managing a distributed database which is performed by a constituent node of a distributed database which manages a plurality of sharding strategies according to FIG. 8; and

FIG. 10 is a diagram illustrating the configuration of a constituent node of a distributed database according to an exemplary embodiment.

### DETAILED DESCRIPTION OF THE EXEMPLARY EMBODIMENTS

Advantages and features of the exemplary embodiments and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the exemplary embodiments will only be defined by the appended claims. Like reference numerals refer to like elements throughout the specification.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Exemplary embodiments are described herein with reference to cross-section illustrations that are schematic illustrations of idealized exemplary embodiments (and intermediate structures). As such, variations from the shapes of the illustrations as a result, for example, of manufacturing techniques and/or tolerances, are to be expected. Thus, these exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the exemplary embodiments.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

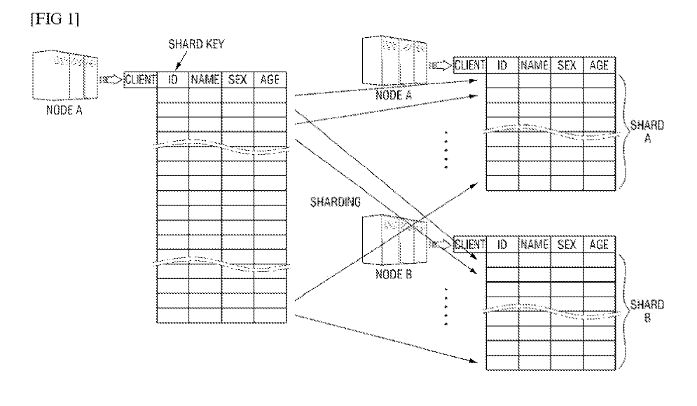

First, the conception of database sharding will be described first with reference to FIG. 1. As described above, sharding a database means separating some of data to other nodes.

As a database partition method in sharding, there may be vertical partitioning and range-based partitioning ways. The vertical partitioning way is to separate each table to different nodes and the range-based partitioning way is to separate one table to different nodes when the table becomes large.

FIG. 1 illustrates the range-based partitioning way. As illustrated in FIG. 1, a client table is stored in the node A and the number of tuples of the client table increases with an increase of clients, such that it is illustrated in the figure that some of the tuples of the client table are separated to the node B, a new node. As illustrated in FIG. 1, when the table increases in size, it is possible to separately store the table to different physical nodes by means of the range-based partitioning way. Although sharding described herein uses the range-based partitioning way, it may use the vertical partitioning in some exemplary embodiments, if necessary.

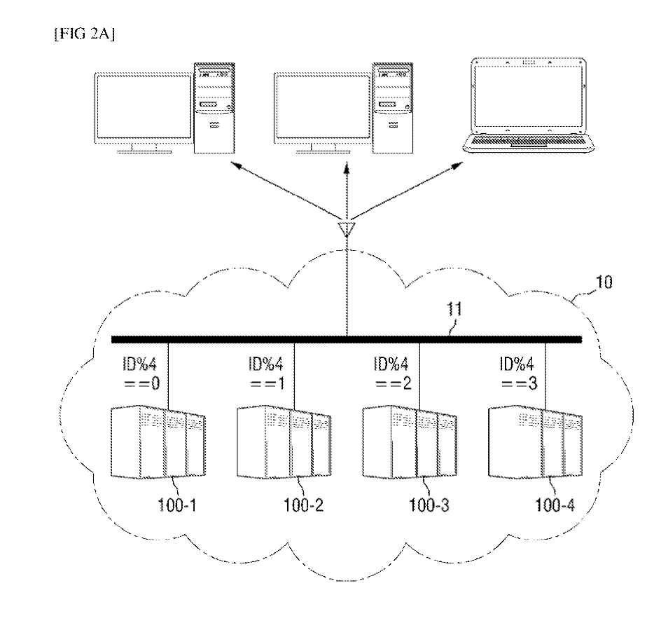

Next, configuration topology of a distributed database system constituted according to an exemplary embodiment will be described with reference to FIGS. 2A and 2B.

A distributed database system 10 according to the present invention may be composed of a plurality of constituent nodes. The constituent nodes each make a response after processing a query received from respective terminals, when the query is the query for data stored therein, and perform filtering-out if it is not. Although not illustrated in FIGS. 2A and 2B, a query interface device that integrally processes queries from terminals may be included in the distributed database system.

FIG. 2A illustrates that nodes 100-1, 100-2, 100-3, and 100-4 are connected in accordance with bus type topology. The nodes 100-1, 100-2, 100-3, and 100-4 are connected to a bus 11 and the same sharding strategy is applied to the nodes 100-1, 100-2, 100-3, and 100-4. That is, the same shard function for the same shard key is applied and the node to be stored may depend on the value of function of the shard function. For example, as illustrated in FIG. 2A, data may be stored in the first node 100-1 when the value of function is 0 as the result of applying a shard function (modular) to an ID attribute, the second node 100-2 when it is 1, the third node 100-3 when it is 2, and the fourth node 100-4 when it is 3.

FIG. 2B illustrates tree type topology. The distributed database system 10 illustrated in FIG. 2B includes nodes 100-5, 100-6, and 100-7 connected to the bus 11 and nodes 100-8 and 100-9 separated once again. The same sharding strategy may be applied to the nodes 100-5 to 7 connected to the bus 11.

However, the sharding strategies applied to the nodes 100-5 to 7 connected to the bus 11 and the nodes 100-8 and 100-9 separated once again may be different. This configuration will be described in detail below.

The distributed database system 10 according to the exemplary embodiments may connect the nodes in another topology other than those illustrated in FIGS. 2A and 2B.

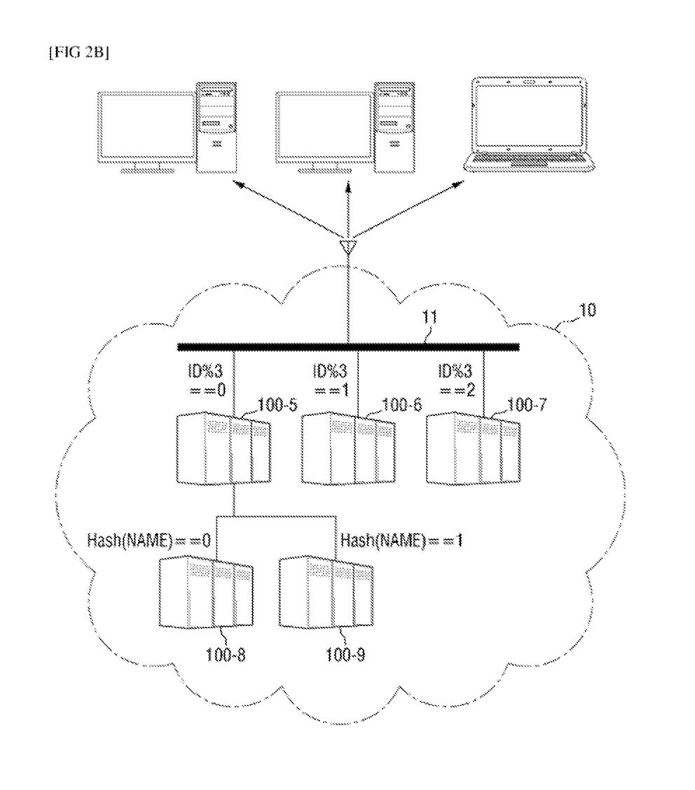

FIG. 3 is a flowchart illustrating a method of managing a distributed database according to an exemplary embodiment. Each operation illustrated in FIG. 3 may be performed by each of the constituent nodes of the distributed database.

First, each node monitors the value of the degree of node concentration (S100). The degree of node concentration may be a value calculated with respect to at least one of the data size of the database and the in-node transaction quantity. The data size of the database may be calculated from the number of tuples of at least one of one or more tables constituting the database and the transaction quantity may be data about the number of transactions generated for the tables or the transactions generated for the tuples in a specific range in each table. The degree of node concentration, which is a value showing how much data processing load is in a node, may increase with an increase of the data size and the transaction quantity, for example.

The nodes monitor whether the degree of node concentration exceeds a sharding limit (S102). The sharding limit may be a constant value set by a manager or may be a value automatically updated by the nodes, including data about use of hardware resources such as the average use rate of the available space in the storage, a CPU, a memory, and the network bandwidth.

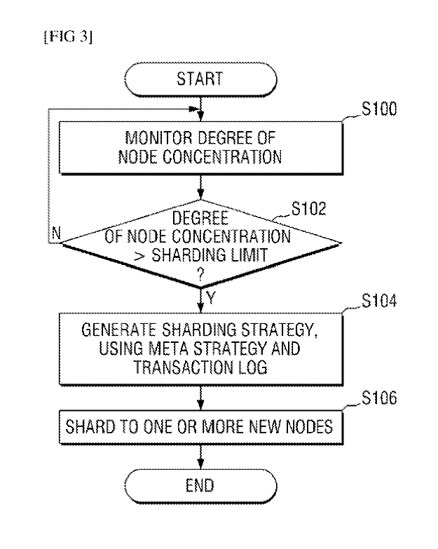

Which node is selected as a partition target node will be described with reference to FIG. 4 for the better understanding. For example, when the distributed database system 10 is composed of three nodes 100-10 to 12, the entire data managed in the distributed database is distributed and stored in the three nodes 100-10 to 12. The database manager would distribute and store the data such that the data is uniformly stored in the nodes, but when the type of accumulation of the data is out of the estimation of the database manager, data 200-2 and transactions may concentrate on a specific node 100-11, as illustrated in FIG. 4. In this case, the node 100-11 is selected as a partition target node. The degree of node concentration is monitored and the degree of node concentration and the sharding limit described above are compared in the partition target node 100-11, and as a result, the partition target node 100-11 determines by the partition target node that it became a partition target node.

The partition target node may shard the in-node data to one or more new nodes in accordance with a predetermined sharding strategy or a sharding strategy determined when it becomes a partition target node.

When a sharding strategy is determined when it becomes a partition target node (S104), there is an effect that it is possible to apply an appropriate sharding strategy in accordance with the database configuration according to data accumulation and the number of transactions for each data. According to an exemplary embodiment, the partition target node may generate one or more sharding strategies by the partition target node, when it becomes a partition target node.

The sharding strategy includes a shard key and a shard function. However, this is for sharding according to the range-based partitioning way, and a corresponding sharding strategy may be generated for sharding according to the vertical partitioning way.

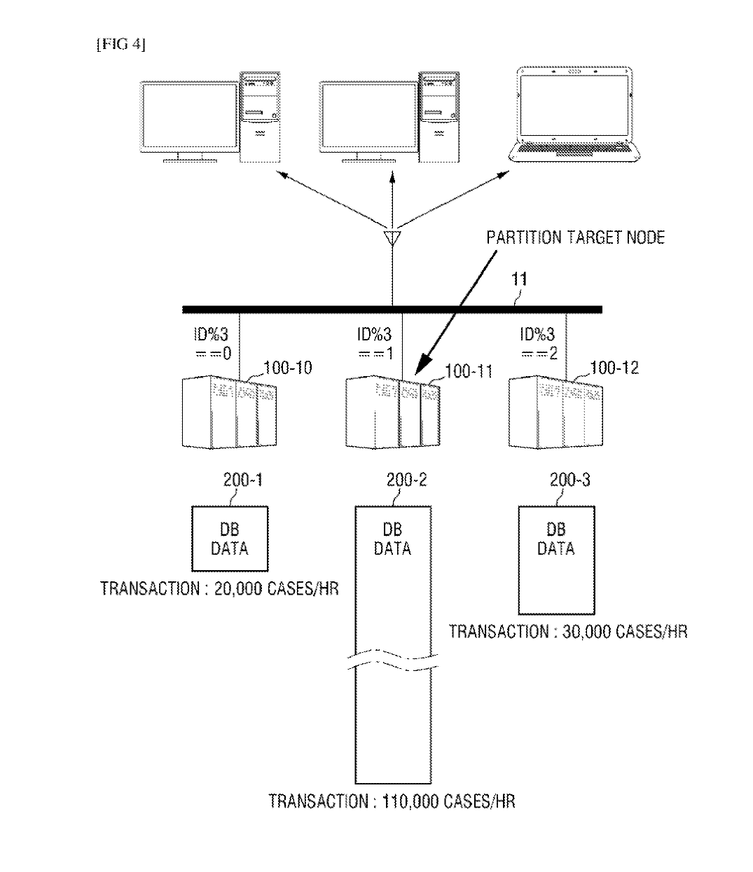

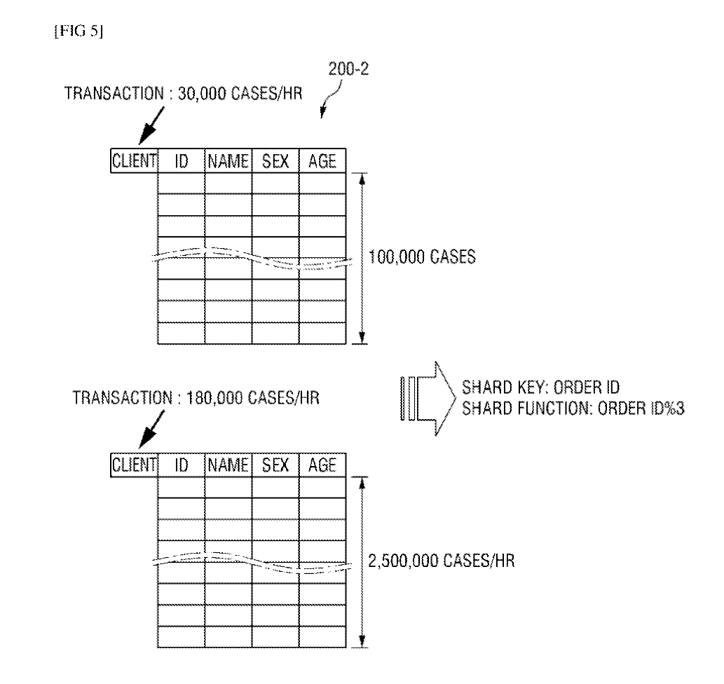

An exemplary embodiment that a partition target node generates a sharding strategy will be described with reference to FIGS. 5 and 6.

FIG. 5 assumes that a database schema includes two tables. Obviously, most databases, for example, a relational database would be composed of more than two tables. In FIG. 5, a database including two tables is assumed for the convenience of description and the scope of the exemplary embodiments may be applied to a database including one or more tables.

It is assumed that the two tables illustrated in FIG. 5, that is, the sizes of the client table and the order table are about 100 thousand cases and about 2.500 thousand cases, respectively. That is, the number of tuples in the client table is about 100 thousands and the number of tuples in the order table is about 2,500 thousands. Further, it is assumed that the number of transactions for the client table is about 30 thousand per hour and the number of transactions for the order table is about 180 thousand per hour. Considering the assumptions, the table to be a partition target of the client table and the order table would be the order table.

A partition target node may determine the number of new nodes on the basis of the number of transactions for the order table. For example, when the reference value of the transactions for each node is about 60 thousand cases per hour, the new nodes for the order table may be two. If all the data is moved to new nodes without using the existing node any more in sharding, the new nodes may be three.

The partition target node may generate a shard function on the basis of the number of the new nodes.

The partition target node may use one of the attributes of the order table as a shard key. Since uniqueness is needed for the attribute of a key, one of the keys in the order table would be used as the shard key. For example, an order ID may be used as a shard key, as illustrated in FIG. 5.

Another exemplary embodiment that a partition target node generates a sharding strategy will be described with reference to FIG. 6.

FIG. 6 assumes that transactions concentrate on the tuples in a specific range. For example, for a database for operating a shopping mall, the number of transactions may be different for each client. For example, for a VIP client, many transactions would be generated in comparison to common clients. The client information is likely to be simultaneously accessed, such that the client information tuples for the VIP client generate many transactions. In FIG. 6, in accordance with this situation, it is assumed that the tuples for common clients (about 98,000 people) in the client table generate about 20,000 cases of transactions per hour, whereas the tuples for VIP clients in the client table generate about 210,000 cases of transactions per hour.

In this case, the client table needs to be separated such that there are a small amount of tuples generating a plurality of transactions in one node. For example, when all of 100 thousand tuples are separated uniformly by 33,000 cases, simply, VIP tuples may concentrate on a specific node, in which the effect of sharding may be reduced by half. Therefore, as illustrated in FIG. 6, speed of processing a database would be increased by the transaction distribution, by dividing only the tuples for the VIP clients into two shards and separating them to new nodes 100-13 and 100-14.

As illustrated in FIGS. 5 and 6, the partition target node may generate a sharding strategy to be applied to the partition target node, using the meta information and transaction log of the database data. The partition target node may generate the shard key and the shard function such that the transactions between the partition target node and the new nodes are uniformly distributed by using the transaction log.

Returning to FIG. 3, a partition target node may shard at least a portion of the data in the partition target node to one or more new nodes in accordance with a predetermined sharding strategy.

The sharding strategy applied to the partition target node and the sharding strategy applied to the new nodes may be the same or may be different. When the sharding strategy applied to the partition target node and the sharding strategy applied to the new nodes are the same, as illustrated in FIG. 2A, the partition target node and the new node may be connected by bus topology.

In contrast, when the sharding strategy applied to the partition target node and the sharding strategy applied to the new nodes are different, as illustrated in FIG. 2B, the partition target node and the new node may be connected by tree type topology. The partition target node may register two or more new nodes as child nodes of the partition target node and may perform a child node registration process that separates and moves the database data of the partition target node to the child nodes. That is, the partition target node may just transmit the queries to be introduced into the child nodes to the child nodes without storing data. The child node registration process may include: sharding the entire database data of the partition target node to two or more new nodes; registering all of the two or more new nodes in the shard specification information of the partition target node as child nodes; and recording the shard specification information of the child nodes on the child nodes.

On the other hand, the constituent nodes constituting the distributed database system according to the present invention may store the shard specification information, which is the information on the range of the data stored in nodes. The constituent nodes each determine whether the query data is that stored in the constituent nodes with reference to the shard specification information when the query is introduced, and then may make a response after processing it, if it is that stored in the constituent nodes, or perform filtering-out if it is not.

After the sharding, the partition target node and the new nodes may update the shard specification information or record new shard specification information.

According to an exemplary embodiment, the partition target node can perform the sharding by the partition target node without an operation of a manager, but according to another exemplary embodiment, at least a guiding operation for the manager may be included in the sharding.

For example, the partition target node may provide grounds allowing a manager to determine the sharding strategies by generating two or more sharding strategies, calculating the points of the generated sharding strategies by using the meta information and transaction log of the database data included in the partition target node, and notifying a predetermined manager of the generated sharding strategies and the calculated points for the sharding strategies.

Further, for example, the partition target node may estimate the database size and the transaction distribution situation after performing sharding in accordance with the sharding strategy, notify the manager of the partition target node, the sharding strategy, and the transaction distribution situation before the sharding, and perform the sharding under confirmation of the manager. That is, the sharding can increase stability, because it is performed under confirmation of a manager.

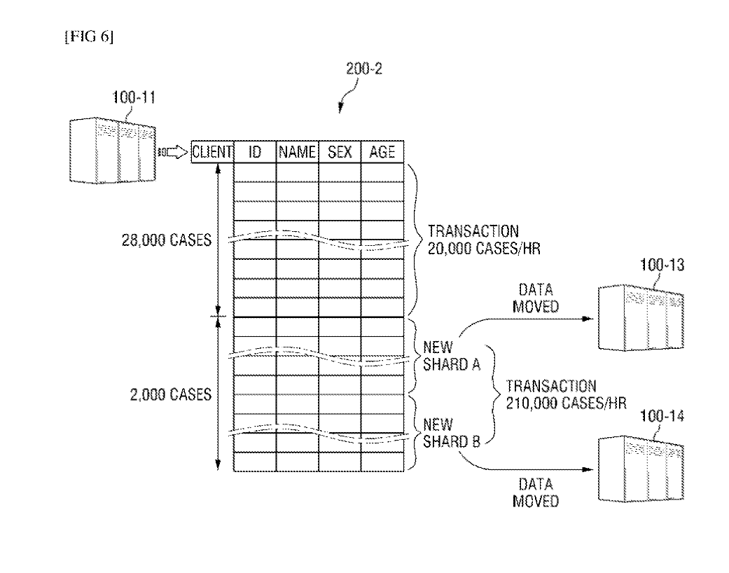

Next, the configuration of the constituent nodes of the distributed database according to an exemplary embodiment will be described with reference to FIG. 7. As illustrated in FIG. 7, the constituent nodes according to the exemplary embodiment may each include a query processor 108, a data shard engine 102, a sharding management information storage 106, and a database data storage 104.

The query processor 108, a module processing introduced queries, may include the shard specification data. The query processor 108 determines whether the query data is that stored in the constituent nodes with reference to the shard specification information when the query is introduced, and then it may make a response after processing it, if it is that stored therein, or perform filtering-out if it is not.

The data shard engine 102 is in charge of monitoring of whether sharding starts, and generation of a sharding strategy. The monitoring method and the sharding strategy generation process by the data shard engine 102 follow the exemplary embodiments described above.

Meta information 160 that is data about the database data 104 such as the tables constituting a database and the sizes of the tables, transaction log 161 that is a record about generation of transactions for each table or the tuples in a specific range in each table, the information 162 on the sharding strategy to be applied when it becomes a partition target node, summary information 163 for the database data 104 such as an aggregate function and the range of the value for non-numerical data may be stored in the sharding management information storage 106.

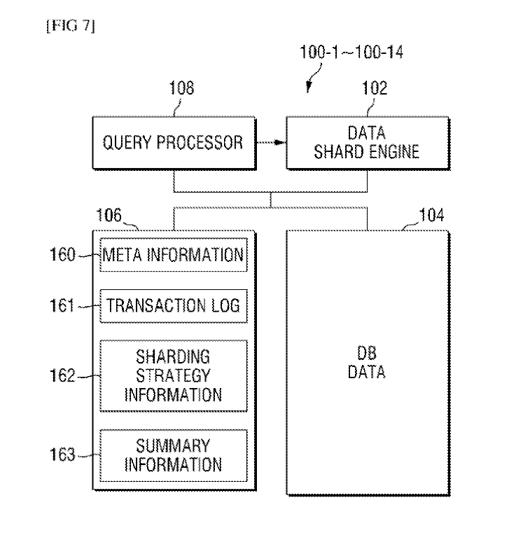

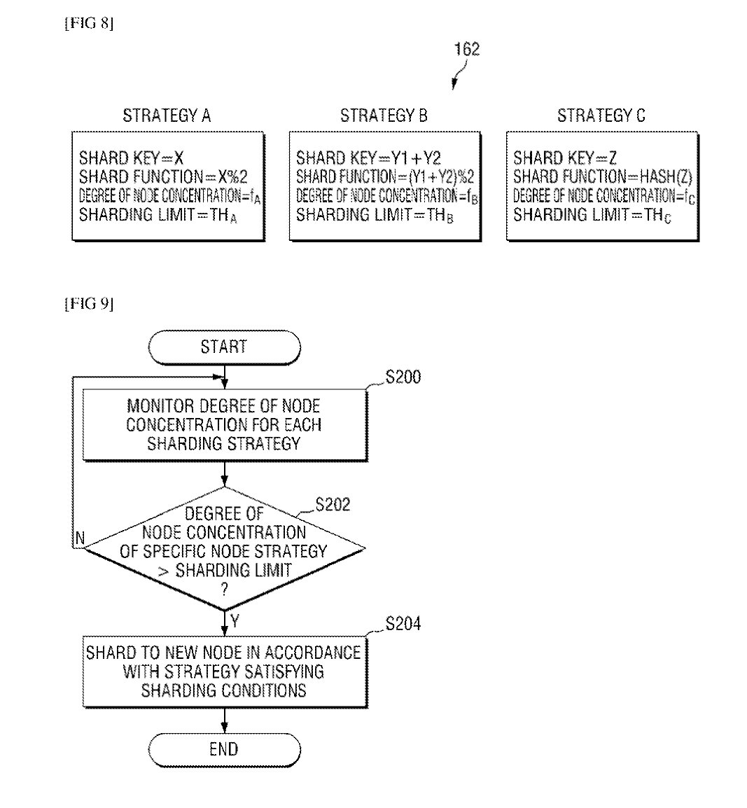

On the other hand, according to an exemplary embodiment, the ground for determining whether to perform sharding may depend on the sharding strategies. Referring to FIG. 8, the equation and the sharding limit for determining the value of the degree of node concentration may be different for each sharding strategy. In this case, the method of managing a distributed database illustrated in FIG. 3 may be changed, as in FIG. 9.

A method of managing a distributed database according to another exemplary embodiment will be described with reference to FIG. 9.

First, the data shard engine 102 of each of the constituent nodes calculates the degree of node concentration in accordance with equations determined for sharding strategies, respectively, which are managed in the type of the sharding strategy information 162 (S200) and determines whether the calculated degree of node concentration exceeds the sharding limit of the corresponding sharding strategy (S202). The node having a sharding strategy with the degree of node concentration more than a sharding limit becomes a partition target node and data is sharded to one or more new nodes in accordance with the sharding strategy (S204).

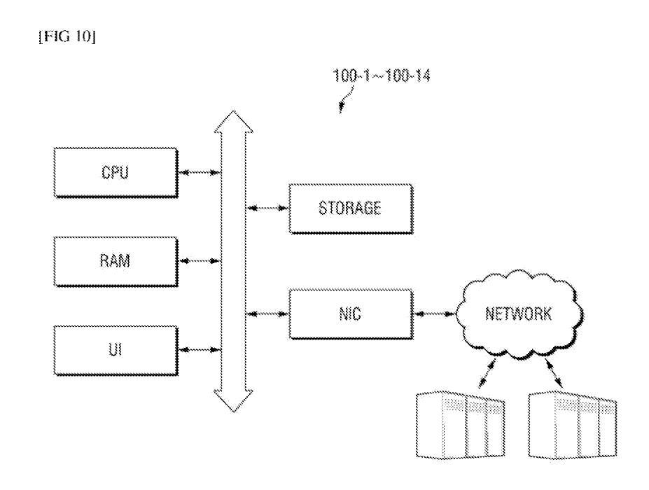

FIG. 10 is a diagram illustrating the configuration of a constituent node of a distributed database according to an exemplary embodiment. As illustrated in FIG. 10, the constituent nodes of a distributed database according to the exemplary embodiment may have a structure with a CPU, a RAM, a UI, a storage, and a network interface connected to a bus.

The CPU may perform a data sharding process including: selecting a database partition target node from the constituent nodes of the distributed database system on the basis of at least one of the data size of the database and the transaction quantity generated for the nodes, generating a sharding strategy that includes a shard key and a shard function and is applied to the partition target node by using the transaction log and meta information of the database data included in the partition target node; and sharding at least a portion of database data of the partition target node to one or more new nodes in accordance with the generated sharding strategy.

According to another exemplary embodiment, the CPU may perform a data sharding process including: managing a plurality of sharding strategies including a shard key, a shard function, a function of the degree of node concentration, and a sharding limit: monitoring whether a sharding strategy with the value of function of the degree of node concentration over the sharding limit is generated; and sharding at least a portion of the database data to one or more new nodes in accordance with the performed sharding strategies when the performed sharding strategies, a sharding strategy over the sharding limit are found by the monitoring.

Further, the storage may store the database data of the node, the meta information of the data, and the transaction information of the node. Further, unlike that illustrated in FIG. 10, the storage may be connected with the CPU, RAM, and NIC through a network.

The foregoing is illustrative of the exemplary embodiments and is not to be construed as limiting thereof. Although a few exemplary embodiments have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of managing a distributed database, the method comprising:
selecting a database partition target node from constituent nodes of a distributed database system based on at least one of a data size stored in each constituent node or a transaction quantity generated for each constituent node;
generating a sharding strategy to be applied to the selected database partition target node using meta information and a transaction log of the distributed database data stored in the selected database partition target node, the sharding strategy comprising a shard key and a shard function; and
sharding at least a portion of the database data stored in the selected database partition target node to one or more new nodes in accordance with the generated sharding strategy.

2. The method of claim 1, wherein the selecting, the generating, and the sharding are performed without an operation of a manager.

3. The method of claim 1, wherein the generating comprises:
generating two or more sharding strategies;
calculating points of the generated two or more sharding strategies using the transaction log and the meta information of the database data included in the selected database partition target node; and
notifying a predetermined manager of the two or more generated sharding strategies and the points calculated for the sharding strategies.

4. The method of claim 1, wherein the sharding includes:
estimating the data size of stored in each constituent node and the transaction distribution after performing sharding in accordance with the generated sharding strategy;
notifying a manager of the selected database partition target node, the generated sharding strategy, and the transaction distribution prior to the sharding; and
performing the sharding under authorization of the manager.

5. The method of claim 1, wherein the selecting includes:
monitoring whether the degree of node concentration calculated from at least one of the data size and the transaction quantity by the constituent nodes of the distributed database system which exceed a sharding limit; and
selecting a node as the selected database partition target node, when the node with the degree of node concentration exceeding the sharding limit is found during the monitoring.

6. The method of claim 1, wherein the generating includes:
determining the number of the new nodes by using the transaction log; and
generating the sharding strategy based on the number of the one or more new nodes.

7. The method of claim 1, wherein the generating includes generating the shard key and the shard function such that the transactions between the selected database partition target node and the new nodes are uniformly distributed, by using the transaction log.

8. The method of claim 1, further comprising:
updating shard specification information of the selected database partition target node and recording the shard specification information of the new nodes onto the new nodes, when the sharding strategy applied to the selected database partition target node is the same as the sharding strategy applied to the one or more new nodes.

9. The method of claim 1, further comprising:
performing a child node registration process of registering two or more new nodes as child nodes of the partition target node, and separating and moving the database data of the selected database partition target node to the two or more new child nodes, when the generated sharding strategy applied to the selected database partition target node is different from the sharding strategy applied to the two or more new nodes.

10. The method of claim 9, wherein the child node registration process includes:
sharding the entire database data of the selected database partition target node to the two or more new nodes;
registering all of the two or more new nodes in the shard specification information of the selected database partition target node as child nodes; and
recording on the child nodes the shard specification information of the child nodes.

11. A method of managing a distributed database, the method comprising:
managing a plurality of sharding strategies comprising a shard key, a shard function, a node concentration degree function, and a sharding limit, by means of constituent nodes of a distributed database system;
monitoring whether a sharding strategy with a value of a function of the degree of node concentration over the sharding limit is generated by means of the constituent nodes;
designating a node with a performed sharding strategy, which is a sharding strategy which exceeds the sharding limit found during the monitoring, in the constituent nodes as a selected database partition target node; and
sharding at least a portion of the database data of the selected database partition target node to one or more new nodes in accordance with the performed sharding strategy.

12. The method of claim 11, wherein the sharding includes sharding all of the database data of the selected database partition target node to two or more new nodes in accordance with the performed sharding strategy.

13. A constituent node of a distributed database, the constituent node comprising:
a processor; and
a storage configured to store database data of the constituent node, meta information of the data, and transaction log information of the constituent node,
wherein the processor performs a data sharding process including: selecting a database partition target node from constituent nodes of the distributed database system on the basis of at least one of a data size stored in each constituent node and transaction quantity generated for each constituent node;
generating a sharding strategy to be applied to the selected database partition target node by using meta information and the transaction log of the database data included in the selected database partition target node, wherein the sharding strategy comprises a shard key and a shard function; and
sharding at least a portion of database data stored in the selected partition target node to one or more new nodes in accordance with the generated sharding strategy.
